(19) United States
(12) Patent Application Publication
(10) Pub. No.: US 2026/0278287 A1
(43) Pub. Date: Sep. 17, 2026

(54) MACHINE LEARNING BASED SYSTEM AND METHOD FOR GENERATING CUSTOMIZED BOOK-LENGTH CONTENT

(71) Applicant: Planbuddy Ltd., Bat Yam (IL)

(72) Inventors: Adir MASHIAH ASGAROV, Bat Yam (IL); Orel BITON, Ashdod (IL)

(73) Assignee: Planbuddy Ltd., Bat Yam (IL)

(21) Appl. No.: 19/368,007

(22) Filed: Oct. 24, 2025

Related U.S. Application Data
(60) Provisional application No. 63/715,920, filed on Nov. 4, 2024.

(51) Int. Cl. G06F 40/40; G06F 40/258; G06N 3/045; G06N 3/0475

(52) U.S. Cl. CPC G06F 40/40; G06F 40/258; G06N 3/045; G06N 3/0475

(57) ABSTRACT

A method for generating content of a book, comprising: determining, by a machine learning processor of a management server, a title, a subtitle and a table of contents based on received user inputs; and generating a plurality of chapters that form content of the book, wherein each chapter is generated independently without consideration of others of the chapters, wherein generating each chapter further comprises: determining subheadings for each chapter based on the user inputs, the title, the subtitle, and the table of contents, wherein each subheading of the plurality of subheadings corresponds to a section of a chapter; and generating content for each section, wherein the content of each section is generated based on one of the subheadings, the user inputs, the title, and the subtitle, wherein each new section is generated with consideration of preceding sections of the same chapter.

### CROSS REFERENCE TO RELATED APPLICATIONS

This application claims the benefit of U.S. Provisional Application No. 63/715,920 filed on Nov. 4, 2024, the contents of which are incorporated herein by reference.

### TECHNICAL FIELD

The disclosure generally relates to automated content generation systems, and more particularly, to a machine learning-based system and method for generating customized book-length content.

### BACKGROUND

Creating personalized book-length content has traditionally been a complex and labor-intensive task. Content creators, including authors and editors, often need to invest significant time and effort to tailor materials to an individual reader's preferences, interests, and specific requirements. This customization process is challenging when creating lengthy, structured content, such as books, that require a cohesive narrative and consistent tone across multiple chapters and sections.

While advances in artificial intelligence (AI), and more specifically in machine learning, have introduced automated content generation tools, these tools often fall short in the context of book-length content creation. Current systems tend to produce repetitive or disjointed text when tasked with generating extended content across multiple chapters or sections. This is particularly problematic for applications that require a cohesive narrative or structured progression, as is common in books.

Existing language models, although powerful, are typically limited by their tendency to either lose contextual relevance over lengthy passages or inadvertently introduce redundancy. Attempts to produce structured, chapter-based content using these models require considerable manual oversight to ensure consistency, uniqueness, and quality across different sections. Furthermore, maintaining a logical flow and thematic continuity throughout a multi-chapter document remains a significant challenge for current automated solutions.

These limitations highlight a gap in the capabilities of existing content generation systems, indicating the need for a more robust, structured approach to generating customized book content autonomously. Therefore, it would be advantageous to provide a solution that overcomes the shortcomings of prior art solutions noted above.

### SUMMARY OF THE DISCLOSURE

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “certain embodiments” may be used herein to refer to a single embodiment or multiple embodiments of the disclosure.

Certain embodiments disclosed herein include a computer-implemented method for generating customized book-length content of a book. The method comprises: determining, by a machine learning processor of a management server, a title, a subtitle and a table of contents of the book based on received user inputs; and generating, by the machine learning processor, a plurality of chapters that form the customized book-length content of the book, wherein each chapter is generated independently without consideration of the other chapters of the plurality of chapters, wherein generating each chapter of the plurality of chapters further comprises: determining, by the machine learning processor, a plurality of subheadings for each chapter based on the user inputs, the title, the subtitle, and the table of contents, wherein each subheading of the plurality of subheadings corresponds to a section of a chapter; and generating, by the machine learning processor, content for each section of the plurality of sections, wherein the content of each section is generated based on one of the plurality of subheadings, the user inputs, the title, and the subtitle, wherein each new section is generated with consideration of preceding sections of the same chapter.

Certain embodiments disclosed herein include a non-transitory computer readable medium having stored thereon instructions for causing a processing circuitry to execute a process for generating customized book-length content of a book. The process comprises: determining, by a machine learning processor of a management server, a title, a subtitle and a table of contents of the book based on received user inputs; and generating, by the machine learning processor, a plurality of chapters that form the customized book-length content of the book, wherein each chapter is generated independently without consideration of the other chapters of the plurality of chapters, wherein generating each chapter of the plurality of chapters further comprises: determining, by the machine learning processor, a plurality of subheadings for each chapter based on the user inputs, the title, the subtitle, and the table of contents, wherein each subheading of the plurality of subheadings corresponds to a section of a chapter; and generating, by the machine learning processor, content for each section of the plurality of sections, wherein the content of each section is generated based on one of the plurality of subheadings, the user inputs, the title, and the subtitle, wherein each new section is generated with consideration of preceding sections of the same chapter.

Certain embodiments disclosed herein include a management server for generating customized book-length content of a book. The system comprises: a processing circuitry; and a memory, the memory containing instructions that, when executed by the processing circuitry, configure the management server to: determine, by a machine learning processor of the management server, a title, a subtitle and a table of contents of the book based on received user inputs; and generate, by the machine learning processor, a plurality of chapters that form the customized book-length content of the book, wherein each chapter is generated independently without consideration of the other chapters of the plurality of chapters, wherein generating each chapter of the plurality of chapters further comprises: determine, by the machine learning processor, a plurality of subheadings for each chapter based on the user inputs, the title, the subtitle, and the table of contents, wherein each subheading of the plurality of subheadings corresponds to a section of a chapter; and generate, by the machine learning processor, content for each section of the plurality of sections, wherein the content of each section is generated based on one of the plurality of subheadings, the user inputs, the title, and the subtitle, wherein each new section is generated with consideration of preceding

### BRIEF DESCRIPTION OF THE DRAWING

In the drawing:

FIG. 1 shows an illustrative network diagram utilized to describe the various embodiments;

FIG. 2 shows an illustrative arrangement of a management server 120 according to an embodiment;

FIG. 3 shows a flowchart of an illustrative method for generating customized book-length content of a book, according to an embodiment; and

FIG. 4 shows a flowchart of an illustrative method for generating chapters that form a customized book-length content of a book, according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

A method for generating customized book-length content of a book is disclosed. The method includes receiving user inputs with respect to an electronic questionnaire presented to a user of a user device; determining a title, a subtitle and a table of contents of the book based on the user inputs; generating a plurality of chapters that forms the customized book-length content of the book, each chapter is generated independently without considering the rest of the plurality of chapters.

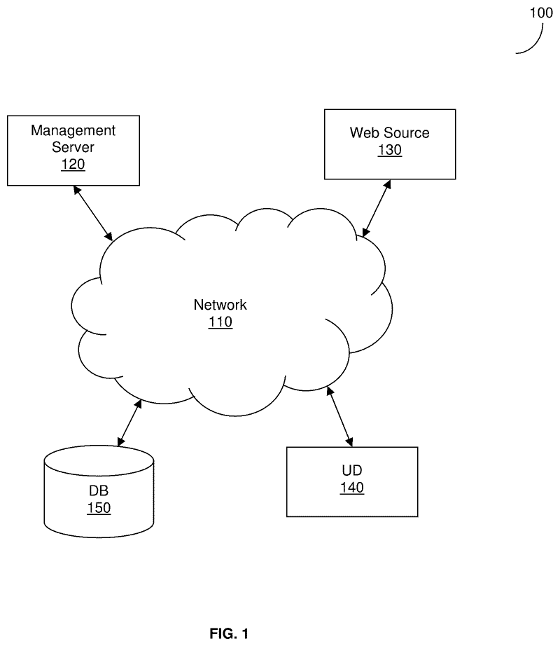

FIG. 1 shows an illustrative network diagram utilized to describe the various embodiments. In the example diagram 100, a management server 120, a web source 130, a user device 140, and a database 150 are communicatively connected to a network 110. The network 110 may be, but is not limited to, a wireless network, a wired network, a wide area network (WAN), local area network (LAN), or any other kind of applicable network, as well as any combination thereof.

The management server 120 may include hardware and software layers which enable the management server 120 to communicate with the different components connected to the network 110, collect data, apply models to the collected data, generate customized book-length content, and so on, as further described herein.

The web source 130 may include, but is not limited to, a website, a database, or similar online resources. The web source 130 is configured to present generated outputs to users in an interactive format and to receive their feedback as user inputs.

The user device 140 may include, but is not limited to, a smartphone, a tablet, a personal computer (PC), a laptop, a wearable device, or any other electronic device capable of supporting the disclosed embodiments. The user device 140 serves as the primary interface for users, enabling them to interact with the system by entering inputs and receiving generated outputs. Using the user device 140, users can respond to electronic questionnaires, submit customized preferences, and provide feedback on generated content in real-time.

The database 150 serves as a digital warehouse, designed to store and manage extensive data sets relevant to the content generation process. This data may include user inputs, questionnaire responses, generated content, feedback provided by users, model parameters, and metadata associated with each customized book project. The database 150 facilitates efficient retrieval and organization of data, allowing the management server 120 to access the necessary information swiftly to generate new content or refine existing content based on user feedback.

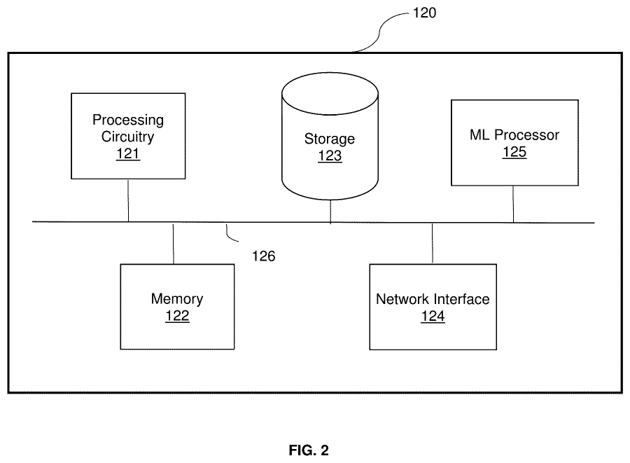

FIG. 2 shows an illustrative arrangement of a management server 120 according to an embodiment. The management server 120 includes a processing circuitry 121 coupled to a memory 122, a storage 123, a network interface 124 and a machine learning (ML) processor 125. In the embodiment, the components of the management server 120 may be communicatively connected via a bus 126.

The processing circuitry 121 may be realized as one or more hardware logic components and circuits. For example, and without limitation, illustrative types of hardware logic components that can be used, include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 122 may be volatile, e.g., RAM, etc.), non-volatile, e.g., ROM, flash memory, etc.), or a combination thereof. In one configuration, computer readable instructions to implement one or more embodiments disclosed herein may be stored in the storage 123.

In another embodiment, the memory 122 is configured to store software. Software shall be construed broadly to mean any type of instructions, whether referred to as software, firmware, middleware, microcode, or hardware description language. Instructions may include code in formats such as source code, binary code, executable code, or any other suitable format of code. The instructions, when executed by the processing circuitry 121, cause the processing circuitry 121 to perform the various processes described herein.

The storage 123 may be magnetic storage, optical storage, and the like, and may be realized, for example, as flash memory or other memory technology, or any other medium which can be used to store the desired information.

The network interface 124 is configured to connect to a network. The network interface 124 may include, but is not limited to a wireless port, e.g., an 802.11 compliant Wi-Fi circuitry) configured to connect to a network. The network interface 124 allows the management server 120 to communicate with databases, other servers, and the like, such that the management server 120 can execute the embodiments discussed herein.

The machine learning processor 125 is configured to perform machine learning based on data received via the network interface 124 as described further herein. In an embodiment, the machine learning processor 125 is further configured to generate customized book-length content of a book based on one or more large language models (LLMs) applied to user inputs. LLMs, that are trained on vast amounts of text data, enable the machine learning processor 125 to detect complex linguistic structures, semantics, and user intent. Leveraging LLMs allows the machine learning processor 125 to generate contextually rich and coherent content that aligns with the user inputs, selected title, subtitle, and table of contents, as further described herein.

In an embodiment, the management server 120 generates an electronic questionnaire that includes a set of questions. The electronic questionnaire is directed to a user and is used to customize the book-length content to a specific user's requirements. The questions may refer to, for example and without limitation, names, jobs, hobbies, family members, funny facts, and so on. According to another embodiment, the questionnaire is displayed on the user device 140 that is used for interacting with, for example, a designated website, designated application, etc.

In an embodiment, the management server 120 receives user inputs with respect to the electronic questionnaire, the user inputs having been supplied by the user device 140. The user inputs may include a response to a predetermined number of questions that form the electronic questionnaire. When the user inputs refer to a number of questions that is below a predetermined threshold value, the management server 120 may be configured to send an alert to the user device 140, notifying the user that more information is required.

In an embodiment, the management server 120 determines a title, a subtitle and a table of contents of the book based on the user inputs. According to one embodiment, the ML processor 125 applies a machine learning model (ML), e.g., a large language model (LLM), to the user inputs, to determine the title, the subtitle, and the table of contents. The title, subtitle and the table of contents are also used later on in the process as an input for a second model, e.g., a large language model (LLM), for generating the book-length content.

According to one embodiment, the title, subtitle and table of contents are presented to the user over the user device 140. According to further embodiment, the management server 120 generates a notification inviting the user to approve the title, subtitle and table of contents. The notification may be transmitted to user device 140 and the user's response received therefrom. Further work to generate the customized book-length content for the book only proceeds upon receiving user approval. According to another embodiment, when approval is not received, e.g., disapproval is received, the management server 120 regenerates one or more of the title, subtitle and table of contents in accordance with the user's response. To that end, the management server 120 may be configured to receive, e.g., from user device 140, a new set of user inputs to use in regenerating or modifying at least one of the title, subtitle and table of contents.

In an embodiment, the management server 120 generates a plurality of chapters, i.e., the content of the chapters, that form the customized book-length content for the book. The content of each chapter is generated independently without consideration of the other chapters of the plurality of chapters that form the book. Each chapter corresponds to an entry in the table of contents. However, the title of the chapter that appears in the table of contents need not also appear at the head of the chapter.

In order to generate the plurality of chapters, the ML processor 125 applies a machine learning model (ML), e.g., a large language model (LLM) to the user inputs, the title, the subtitle, and the table of contents. This may be a different, e.g., a second, LLM from the one that was used to generate the title, the subtitle, and the table of contents. The model is adapted to at least determine a plurality of subheadings for each chapter. The plurality of subheadings divides each chapter into a plurality of sections. Also, the subheadings represent the topic of each section of a specific chapter.

After the subheadings of a specific chapter are determined, the model uses the subheadings, the user inputs, the title and the subtitle as inputs and generate content for each section of the plurality of sections of a specific chapter. The content of each section of a chapter is generated sequentially, e.g., the content is created in order of the corresponding subheadings of the specific chapter to which the subheadings belong. Each new section is generated with consideration of the preceding sections of the same chapter. Note that each determined subheading need not appear in a chapter at the head of the section that corresponds to the subheading.

The advantage of the disclosed system and method is that it facilitates high-quality creation of book-length content using machine learning, while maintaining coherence, consistency, and customization throughout the content. By leveraging large language models (LLMs), the system can generate content that not only aligns with user preferences but also flows logically within each chapter and across the entire book. This method enables independent generation of each chapter to prevent redundancy, yet ensures continuity within each chapter by considering preceding sections. Additionally, the system allows for iterative refinement based on user feedback, enhancing personalization and adapting to specific user requirements, resulting in a unique, customized reading experience.

The disclosure teaches a technological solution to limitations associated with conventional content generation tools. By implementing a distributed, server-based architecture that integrates a dedicated machine learning processor, the system is able to dynamically generate long-form textual content with structural coherence and semantic alignment. The disclosure enables scalable, real-time processing of user-specific data to produce structured, multi-chapter content without requiring template-based scripting or rule-driven engines. Furthermore, by maintaining contextual relevance across sequential sections within each chapter, the system addresses inherent limitations of existing language models when applied to extended narrative tasks thereby providing an improvement to such systems. In particular, the enhancements disclosed herein collectively improve the reliability, efficiency, and quality of systems that perform automated content generation through technological means.

It should be understood that the embodiments described herein are not limited to the specific architecture illustrated in FIG. 2, and other architectures may be equally used without departing from the scope of the disclosed embodiments.

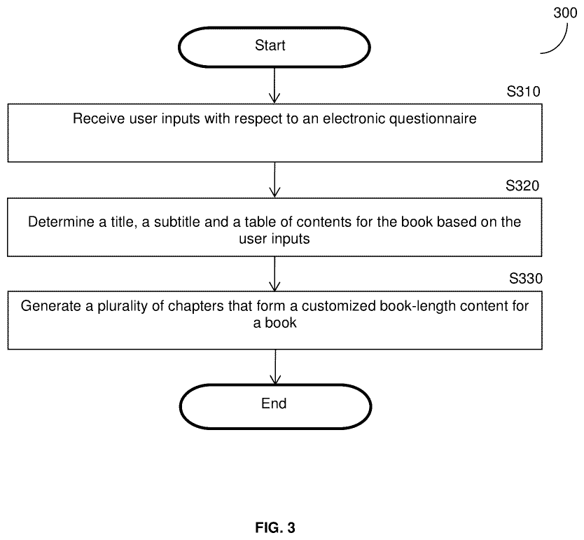

FIG. 3 shows a flowchart of an illustrative method for generating customized book-length content of a book, according to an embodiment. The disclosed method may be executed by the management server of FIG. 2.

At S310, user inputs are received with respect to an electronic questionnaire displayed to the user. The user inputs may include for example, personal information, names, hobbies, habits, funny stories, etc.

At S320, a book title, a book subtitle and a table of contents of the book are determined based on the user inputs, as further discussed herein with respect of FIG. 2. The book title, subtitle and table of contents are further presented to the user via the user device of the user. Thus, the user can approve, or ask to regenerate, one or more of the title, subtitle and table of contents. S320 may further include applying a machine learning (ML) model, e.g., a large language model (LLM), to the user inputs, to determine the title, the subtitle, and the table of contents.

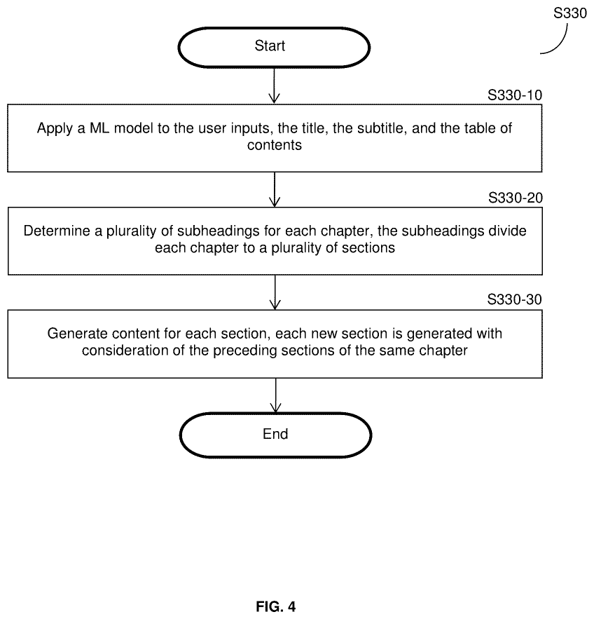

At S330, a plurality of chapters that form the customized book-length content of the book are generated. Each chapter is generated independently without consideration of the other chapters of the plurality of chapters that form the book. It should be noted that the process of generation of the plurality of chapters is further discussed in greater details with respect of FIG. 4.

FIG. 4 shows a flowchart of an illustrative method for generating chapters that form a customized book-length content of a book, according to an embodiment. The disclosed method may be executed by the management server of FIG. 2.

At S330-10, a machine learning (ML) model, e.g., a large language model (LLM), is applied to the user inputs, the title, the subtitle, and the table of contents. The model is adapted to determine a plurality of subheadings for each chapter.

At S330-20, a plurality of subheadings is determined for each chapter. The subheadings divide each chapter to a plurality of sections.

At S330-30, content is generated for each section of the plurality of sections. Each new section is generated with consideration of the preceding sections of the same chapter. In an embodiment, S330-30 further includes applying the model to the subheadings, the user inputs, the title and the subtitle, to generate the content for each section of the plurality of sections of a specific chapter.

The principles of the disclosure are implemented as hardware, firmware, software, or any combination thereof. Moreover, the software is preferably implemented as an application program tangibly embodied on a program storage unit or computer readable medium. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit.

All examples and conditional language recited herein are intended for pedagogical purposes to aid the reader in understanding the principles of the disclosure and the concepts contributed by the inventor to furthering the art and are to be construed as being without limitation to such specifically recited examples and conditions. Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

A person skilled-in-the-art will readily note that other embodiments of the disclosure may be achieved without departing from the scope of the disclosed disclosure. All such embodiments are included herein. The scope of the disclosure should be limited solely by the claims thereto.

What is claimed is:

1. A computer-implemented method for generating customized book-length content of a book, the method comprising:
determining, by a machine learning processor of a management server, a title, a subtitle and a table of contents of the book based on received user inputs; and
generating, by the machine learning processor, a plurality of chapters that form the customized book-length content of the book, wherein each chapter is generated independently without consideration of the other chapters of the plurality of chapters, wherein generating each chapter of the plurality of chapters further comprises:
determining, by the machine learning processor, a plurality of subheadings for each chapter based on the user inputs, the title, the subtitle, and the table of contents, wherein each subheading of the plurality of subheadings corresponds to a section of a chapter; and
generating, by the machine learning processor, content for each section of the plurality of sections, wherein the content of each section is generated based on one of the plurality of subheadings, the user inputs, the title, and the subtitle, wherein each new section is generated with consideration of preceding sections of the same chapter.

2. The method of claim 1, further comprising:
receiving, by the management server from a user device over a network, the user inputs in response to an electronic questionnaire supplied to a user device.

3. The method of claim 1, wherein the content for each section of one of the plurality of chapters is generated sequentially in order of corresponding subheadings of one of the plurality of chapters.

4. The method of claim 1, wherein the machine learning processor employs a large language model (LLM) to determine the title, the subtitle and the table of contents.

5. The method of claim 4, wherein the machine learning processor employs a second large language model (LLM) to generate the plurality of chapters.

6. The method of claim 5, wherein the machine learning processor employs the second large language model (LLM) to generate determine the plurality of subheadings and to generate content for each section of the plurality of sections.

7. The method of claim 1, wherein the determining of the plurality of subheadings is performed only after receiving approval for the subtitle, and the table of contents.

8. The method of claim 7, wherein the approval is a user approval indicated by the user to a user device and received by the management server from the user device.

9. The method of claim 1, wherein, when an indication of disapproval for at least one of the title, the subtitle and the table of contents is received after having been generated:
regenerating the at least one of the title, the subtitle and the table of contents for which disapproval was received; and
using the regenerated one of the title, the subtitle and the table of contents as the corresponding one of title, the subtitle and the table of contents in generating the plurality of chapters.

10. A non-transitory computer readable medium having stored thereon instructions for causing a processing circuitry to execute a process for generating customized book-length content of a book, the process comprising:
determining, by a machine learning processor of a management server, a title, a subtitle and a table of contents of the book based on received user inputs; and
generating, by the machine learning processor, a plurality of chapters that form the customized book-length content of the book, wherein each chapter is generated independently without consideration of the other chapters of the plurality of chapters, wherein generating each chapter of the plurality of chapters further comprises:
determining, by the machine learning processor, a plurality of subheadings for each chapter based on the user inputs, the title, the subtitle, and the table of contents, wherein each subheading of the plurality of subheadings corresponds to a section of a chapter; and
generating, by the machine learning processor, content for each section of the plurality of sections, wherein the content of each section is generated based on one of the plurality of subheadings, the user inputs, the title, and the subtitle, wherein each new section is generated with consideration of preceding sections of the same chapter.

11. A management server for generating customized book-length content of a book, comprising:
a processing circuitry; and
a memory, the memory containing instructions that, when executed by the processing circuitry, configure the management server to:
determine, by a machine learning processor of the management server, a title, a subtitle and a table of contents of the book based on received user inputs; and
generate, by the machine learning processor, a plurality of chapters that form the customized book-length content of the book, wherein each chapter is generated independently without consideration of the other chapters of the plurality of chapters, wherein generating each chapter of the plurality of chapters further comprises:
determine, by the machine learning processor, a plurality of subheadings for each chapter based on the user inputs, the title, the subtitle, and the table of contents, wherein each subheading of the plurality of subheadings corresponds to a section of a chapter; and
generate, by the machine learning processor, content for each section of the plurality of sections, wherein the content of each section is generated based on one of the plurality of subheadings, the user inputs, the title, and the subtitle, wherein each new section is generated with consideration of preceding sections of the same chapter.

12. The management server of claim 11, wherein the processing circuitry is further configured to:
receive, from a user device over a network, the user inputs in response to an electronic questionnaire supplied to a user device.

13. The management server of claim 11, wherein the content for each section of one of the plurality of chapters is generated sequentially in order of corresponding subheadings of one of the plurality of chapters.

14. The management server of claim 11, wherein the machine learning processor employs a large language model (LLM) to determine the title, the subtitle and the table of contents.

15. The management server of claim 14, wherein the machine learning processor employs a second large language model (LLM) to generate the plurality of chapters.

16. The management server of claim 15, wherein the machine learning processor employs the second large language model (LLM) to generate determine the plurality of subheadings and to generate content for each section of the plurality of sections.

17. The management server of claim 11, wherein the determining of the plurality of subheadings is performed only after receiving approval for the subtitle, and the table of contents.

18. The management server of claim 17, wherein the approval is a user approval indicated by the user to a user device and received by the management server from the user device.

19. The management server of claim 11, wherein, when an indication of disapproval for at least one of the title, the subtitle and the table of contents is received after having been generated:
regenerating the at least one of the title, the subtitle and the table of contents for which disapproval was received; and
using the regenerated one of the title, the subtitle and the table of contents as the corresponding one of title, the subtitle and the table of contents in generating the plurality of chapters.
